(19) United States
(12) Patent Application Publication
(10) Pub. No.: US 2006/0179063 A1
(43) Pub. Date: Aug. 10, 2006

(54) Method and system for reducing dependent eligibility fraud in healthcare programs

(76) Inventors: Alan B. Rose, Roswell, GA (US); Jye-Chyi Lu, Alpharetta, GA (US)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 11/350,259

(22) Filed: Feb. 8, 2006

Related U.S. Application Data
(60) Provisional application No. 60/651,133, filed on Feb. 8, 2005.

(51) Int. Cl. G06F 17/30

(52) U.S. Cl. 707/10

(57) ABSTRACT

The present invention provides a system and method for reducing fraud in a healthcare benefits plan using a predictive model to identify those subscribers having a high probability of maintaining an ineligible dependent under the plan. The predictive model may be developed using subscriber data of the subscriber group being analyzed or using a base case subscriber group having certain similarities to the subscriber group being analyzed. In accordance with the present invention an analysis engine receives subscriber data of subscribers in a subscriber group, which includes data of at least one subscriber reported to have maintained an ineligible dependent under the healthcare benefits plan, and develops a predictive model using the subscriber data. A predictive engine applies the subscriber data to the predictive model. A reporting component then uses an output of the predictive model to report a score for at least one subscriber of the healthcare benefits plan, wherein the score indicates a probability that the subscriber is maintaining an ineligible dependent under the healthcare benefits plan.

### RELATED APPLICATION

This application claims the benefit of priority of U.S. provisional application Ser. No. 60/651,133, filed Feb. 8, 2005, which is relied on and incorporated herein by reference.

### FIELD OF THE INVENTION

The present invention relates generally to a method and system for reducing fraud in a benefits plan, such as a healthcare benefits plan. More particularly, the present invention relates to a method and system that uses predictive modeling to indicate a probability that a subscriber to a benefits plan is engaged in dependent eligibility fraud, i.e., is maintaining one or more dependents under the plan when such dependent(s) is/are ineligible for coverage under the benefits plan.

### BACKGROUND OF THE INVENTION

Healthcare benefits plan providers must continually grapple with the increasing costs associated with the delivery of healthcare services to plan subscribers and their covered dependents. Unfortunately, a major contributor to such costs is fraud. According to the General Accounting Office, 10% of every healthcare dollar in this nation is lost to fraudulent and wasteful provider claims. Applying this estimate to all health care spending means more than $100 billion dollars is lost to fraud and abuse each year.

Consequently, various systems and methods have been proposed to reduce and prevent fraud in healthcare systems. Such conventional approaches have generally focused on a review of the claims submitted for payment to the healthcare plan. In this regard, healthcare fraud prevention and identification efforts have typically targeted such schemes as billing for services not rendered, billing for services not medically necessary, double billing for services provided, upcoding, unbundling, and fraudulent costs reported by institutional providers.

Not as common are systems and methods aimed at reducing dependent eligibility fraud, i.e., the maintaining of a dependent under a healthcare plan that is ineligible for coverage under the plan's eligibility guidelines. Indeed, historically healthcare plan subscribers have been permitted to add dependents (e.g., spouse, child, or domestic partner) to their coverage based on the “honor system.” Even today, healthcare plan administrators typically do not require evidence to support a subscriber's claim that an individual, enrolled for coverage by a subscriber as a dependent, meets the plan's specific requirements to qualify for coverage as a dependent.

A major challenge to developing a system or method for reducing dependent eligibility fraud has been the complexity and uniqueness of each healthcare plan's eligibility definitions. Each healthcare benefits plan (whether employer sponsored, government sponsored, or offered to consumers via retail channels) maintains a strict set of definitions that set forth whom is eligible for coverage under the plan. Each plan lists a set of eligibility definitions in a plan document (required by the United States Employee Retirement Income Security Act (“ERISA”)) that is commonly referred to as the “Summary Plan Description.” Although similarities exist among individual sets of eligibility definitions, generally, each plan is different. For example, whereas one healthcare plan may permit coverage of an unmarried dependent child who is (1) under the age of 19 or (2) is aged 19 to 25 and enrolled in a full-time school, another healthcare plan may allow coverage of an unmarried dependent child who is (1) under the age of 18, or (2) aged 18 to 23, a full-time student at an accredited educational institution, living at home, and dependent upon the subscriber for more than 50% of financial support. Thus, a subscriber's child that is over 19, a full-time student, and lives at school would be eligible under the first plan but not the second. Accordingly, a significant obstacle to providing an effective system or method for reducing dependent eligibility fraud has been the need to develop a system or method that may be used to reduce fraud across a wide range of healthcare plans.

Creating a system or method for identifying dependent eligibility fraud has been a difficult task for other reasons as well. First, there is limited knowledge concerning the characteristics of dependent eligibility fraud in any given healthcare plan subscriber population. Second, most plan administrators lack the experience required to detect dependent eligibility fraud in their healthcare plan. Third, a considerable challenge to detecting ineligible dependents is that some subscribers are deliberately attempting to deceive the plan administrator. Finally, there are also subscribers who maintain coverage for ineligible dependents due to a misunderstanding of the plan's eligibility provisions.

Nevertheless, a small, but increasing, number of healthcare plan providers have recognized and begun to address the issue of dependent eligibility fraud and abuse. The typical approach for such providers has been to engage in various auditing procedures to identify dependent eligibility fraud. The results have been notable. For example, the following list of healthcare plan providers and the respective number of ineligible dependents identified through their dependent audit processes was gathered from published reports:
DaimlerChrysler—27,000 (USA Today);
Delta Airlines—7,000 (Atlanta Journal-Constitution); and
Ford Motor Company—50,000 (Wall Street Journal).

In general, a dependent eligibility audit is a review, conducted by a healthcare plan administrator or third party, of covered dependents who participate in a healthcare benefits plan. The audit process is designed to verify that only dependents of healthcare plan subscribers who meet the plan's specific definitions of eligibility maintain dependent healthcare plan coverage. The conventional auditing procedures used to reduce dependent eligibility fraud include single-phase and multi-phase approaches.

The single-phase audit process typically consists of a document audit. In a document audit, subscribers are asked to certify or provide proof of the eligibility of their covered dependent(s). For example, subscribers may be asked to provide a marriage certificate, a birth certificates, student registration records, court-ordered dependent coverage documentation, physician statements regarding dependent disabilities, and/or federal tax returns to support a claim of a dependent under the healthcare benefits plan. Dependents of subscribers who do not and/or cannot submit the required documents by the end of the phase are disenrolled.

The multi-phase audit process typically includes an amnesty audit phase and a document audit phase. An amnesty audit offers subscribers a finite period of time to correct their dependent records without penalty. Subscribers with covered dependents are required to review the plan's specific dependent definition set and must confirm eligibility or ineligibility for each dependent. After the amnesty audit, subscribers with covered dependents are then required to participate in a document audit, as previously described. According to published reports, all three of the example healthcare plans cited above performed such a multi-phase audit that included a requirement that each covered subscriber with dependents complete a document audit.

Another variation of the multi-phase audit process is to perform several document audits, each on a different subset (less than 100%) of subscribers. For instance, a document audit might be performed exclusively on subscribers who have last names that begin with the letter “A,” followed by a second document audit on subscribers who have last names that begin with the letter “B.”

The current reliance on extensive auditing procedures, however, presents several problems. First, the administrative cost of performing audits, particularly document audits, is substantial. Second, document audits can create a measurable, negative impact on subscribers because they require subscribers who cover dependents to perform a substantial amount of administrative work. Furthermore, subscribers may perceive that the healthcare plan administrator does not trust them. Third, if many of a plan's subscribers are required to participate in a document audit, the process creates an administrative burden on a substantial number of subscribers who are not extending coverage to ineligible dependents.

Finally, conducting document audits on a random subset of subscribers is simply not effective. In this regard, the probability of selecting the subscribers that are maintaining ineligible dependents is extremely small. For example, for a simple case wherein one out of ten subscribers is maintaining an ineligible dependent, a random document audit of one subscriber has a statistical chance of identifying fraud equal to 1/10 or 10%. For a low complexity case wherein two out of ten subscribers are maintaining an ineligible dependent, a random document audit of two subscribers has a statistical chance of identifying fraud equal to 1/45 or 2.2%. For a medium complexity case wherein five out of one hundred subscribers are maintaining an ineligible dependent, a random document audit of five subscribers has a statistical chance of identifying fraud equal to 1/75,287,520 or close to 0%. As healthcare plans typically cover a subscriber population that is many times the magnitude of the examples above, the probability of successfully selecting subscribers by random means is statistically insignificant.

For the reasons listed above, many healthcare plan administrators elect to forgo a dependent eligibility audit and, as such, continue to incur fraudulent claims associated with ineligible dependents remaining in the plan. In the case of self-insured healthcare plans, the financial burden of fraudulent claims is typically shared by the healthcare plan provider as well as all subscribers in the healthcare plan.

A need therefore exists for an improved method and system for effective reduction of dependent eligibility fraud in healthcare plans that do not necessitate an extensive document audit of healthcare program subscribers.

### SUMMARY OF THE INVENTION

The present invention meets this need and overcomes the problems above by providing a system and method for reducing fraud in a healthcare benefits plan that uses a predictive model developed using data of subscribers previously reported to have maintained an ineligible dependent. Through the use of the predictive model, the present invention identifies, with greater accuracy, those subscribers having a high probability of maintaining an ineligible dependent under the healthcare benefits plan. Consequently, only a limited number of subscribers need be subjected to a document audit and the chances of accurately selecting fraudulent subscribers for the audit are significantly increased. For these reasons, the present invention reduces the administrative costs and negative impacts currently associated with reducing eligibility fraud in healthcare benefits plans.

In accordance with one embodiment of the present invention, an analysis engine receives subscriber data of subscribers in a subscriber group, which includes data of at least one subscriber reported to have maintained an ineligible dependent under the healthcare benefits plan, and develops a predictive model using the subscriber data. A predictive engine applies the subscriber data to the predictive model. A reporting component then uses an output of the predictive model to report a score for at least one subscriber of the healthcare benefits plan, wherein the score indicates a probability that the subscriber is maintaining an ineligible dependent under the healthcare benefits plan. In this regard, the predictive model is used to identify those subscribers in the subscriber group that exhibit a measurably higher probability of maintaining ineligible dependents in the healthcare benefits plan than the average subscriber.

In another embodiment of the present invention, the analysis engine receives subscriber data of subscribers in a base case subscriber group, which includes data of at least one subscriber reported to have maintained an ineligible dependent under a benefits plan, and develops a predictive model using the subscriber data. The base case subscriber group may be similar to the first subscriber group, such as having members within the same industry. Thus, the subscriber data of subscribers in the base case subscriber group is used to create a predictive model for use in analyzing the subscriber data of subscribers in a separate and preferably similar subscriber group to the base case subscriber group.

Accordingly, in the described embodiment, the predictive engine receives subscriber data of subscribers in the first subscriber group and applies the subscriber data to the predictive model. The reporting component then uses an output of the predictive model to report a score for at least one subscriber of the healthcare benefits plan, wherein the score indicates a probability that the subscriber is maintaining an ineligible dependent under the healthcare benefits plan. In this regard, the predictive model, which was developed from subscriber data of the base case subscriber group, is used to identify those subscribers in the first subscriber group that exhibit a measurably higher probability of maintaining ineligible dependents in the healthcare benefits plan than the average subscriber. Consequently, once the predictive model is developed using the subscriber data of the base case subscriber group, the subscriber data of numerous other subscriber groups may be applied to the predictive model and analyzed to identify subscribers likely of maintaining an ineligible dependent.

In further embodiments, a decision classifier is used to designate those subscribers for which the eligibility of their claimed dependent(s) should be verified, such as by a document audit, because the score indicates that such subscribers are significantly likely to be maintaining an ineligible dependent. In such embodiment, the user may use the score and the decision classifier and elect to perform one or more additional audits, such as an amnesty audit, a document audit, or both, on all or a subset of the subscribers in the subscriber group to determine whether they are in fact maintaining an ineligible dependent.

In still further embodiments, confirming information received from the additional audit(s), which confirms whether the subscriber(s) is maintaining an ineligible dependent, may then be used to update the predictive model and refine the predictive model.

It is thus an object of the present invention to provide a system and method that enables a healthcare plan provider to achieve more accurate results than would be achieved through the performance of a randomly selected document audit.

Another object of the present invention is to provide a system and method that significantly reduces the administrative costs and negative impacts to subscriber relations by reducing the subset of subscribers necessary to participate in a document audit.

Yet another object of the present invention is to provide a system and method that may be used to reduce fraud in a wide range of healthcare plans having different sets of eligibility definitions.

Still another object of the present invention is to provide a system and method that allows for multiple data sources to be utilized either individually or in combination. For example, a healthcare plan administrator may elect to leverage on a predictive model developed for a separate preferably similar subscriber group, such as a subscriber group that shares demographic characteristics with the administrator's subscriber group, or elect to develop a predictive model based solely data specific to that administrator's subscriber population.

A still further object of the present invention is to provide a system and method that reduces fraud in healthcare benefits plans using incomplete information. In this regard, the present invention provides a method for developing a predictive model using data from reported results that may or may not be true.

Another object of the present invention is to provide a system and method wherein the predictive model may be updated and refined to provide a continuous learning tool for the healthcare plan provider that improves its prediction power over time.

Further objects, features and advantages will become apparent upon consideration of the following detailed description of the invention when taken in conjunction with the drawings and the appended claims.

### BRIEF DESCRIPTION OF THE DRAWINGS

FIG. 1 is a relational diagram showing a system for reducing fraud in a benefits plan in an embodiment of the present.

FIG. 2 is a flow diagram of a method for reducing fraud in a benefits plan in an embodiment of the present invention.

FIG. 3 is a flow diagram of a method for reducing fraud in a benefits plan in another embodiment of the present invention.

FIG. 4 is a sample output of a predictive model used to reduce fraud in a benefits plan in an embodiment of the present invention.

FIG. 5 is a sample report indicating a probability that each subscriber is maintaining an ineligible dependent in an embodiment of the present invention.

FIG. 6 is a flow diagram of a first case study conducted to test the accuracy of the present invention.

FIG. 7 is a flow diagram of a second case study conducted to further test the accuracy of the present invention.

### DETAILED DESCRIPTION OF THE INVENTION

I. System for Reducing Fraud in a Benefits Plan.

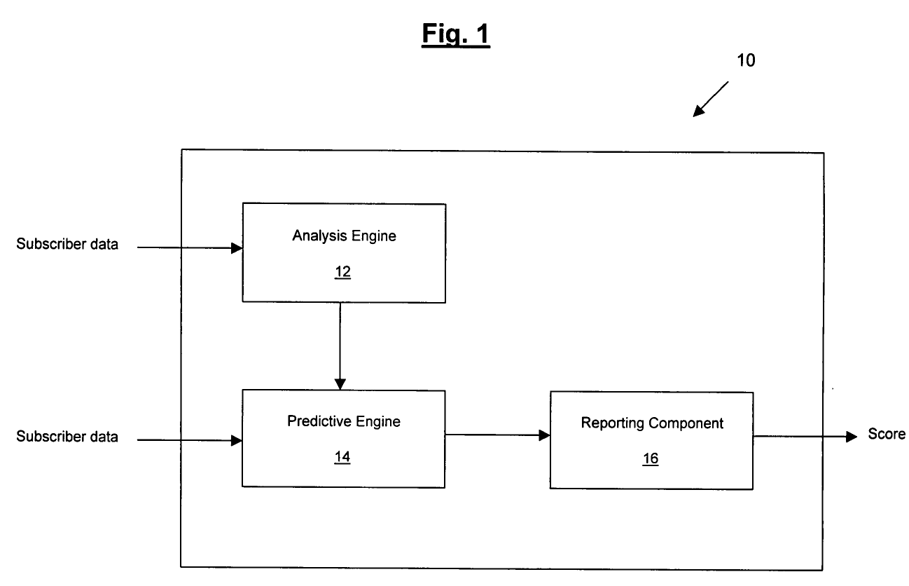

Referring now to the drawings, in which like reference numerals represent like parts throughout the several views, FIG. 1 shows a system 10 in accordance with the present invention for reducing fraud in a healthcare benefits plan. The system 10 comprises an analysis engine 12 a predictive engine 14 and a reporting component 16.

A. Same Subscriber Group.

In one embodiment of the present invention, the analysis engine 12 receives subscriber data of subscribers in a subscriber group, which includes data of at least one subscriber reported to have maintained an ineligible dependent under the healthcare benefits plan, and develops a predictive model using the subscriber data. The predictive engine 14 applies the subscriber data to the predictive model. The reporting component 16 then uses an output of the predictive model to report a score for at least one subscriber of the healthcare benefits plan, wherein the score indicates a probability that the subscriber is maintaining an ineligible dependent under the healthcare benefits plan. In this regard, the predictive model is used to identify those subscribers in the subscriber group that exhibit a measurably higher probability of maintaining ineligible dependents in the healthcare benefits plan than the average subscriber.

B. Separate Subscriber Groups—Using a Base Case.

In another embodiment of the present invention, the analysis engine 12 receives subscriber data of subscribers in a base case subscriber group, which includes data of at least one subscriber reported to have maintained an ineligible dependent under a benefits plan, and develops a predictive model using the subscriber data. The base case subscriber group may be similar to the first subscriber group, such as having members within the same industry. Thus, the subscriber data of subscribers in the base case subscriber group is used to create a predictive model for use in analyzing the subscriber data of subscribers in the first subscriber group, a separate and preferably similar subscriber group to the base case subscriber group.

Accordingly, in the described embodiment, the predictive engine 14 receives subscriber data of subscribers in the first subscriber group and applies the subscriber data to the predictive model. The reporting component 16 then uses an output of the predictive model to report a score for at least one subscriber of the healthcare benefits plan, wherein the score indicates a probability that the subscriber is maintaining an ineligible dependent under the healthcare benefits plan. In this regard, the predictive model, which was developed from subscriber data of the base case subscriber group, is used to identify those subscribers in the first subscriber group that exhibit a measurably higher probability of maintaining ineligible dependents in the healthcare benefits plan than the average subscriber. It will be appreciated that once the predictive model is developed using the subscriber data of the base case subscriber group, the subscriber data of numerous other subscriber groups may be applied to the predictive model and analyzed to identify subscribers likely of maintaining an ineligible dependent.

II. Method for Reducing Fraud in a Benefits System.

A. Same Subscriber Group.

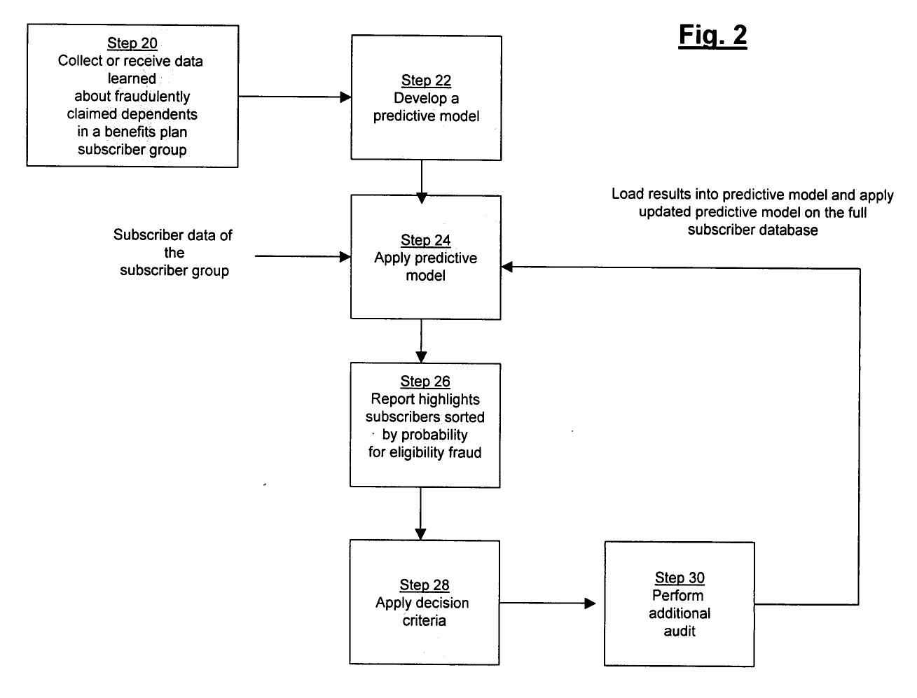

With reference to FIG. 2, a method is shown for reducing fraud in a healthcare benefits plan using the system 10 in one embodiment of the present invention. Providers of healthcare benefits plans typically maintain a census, or database, that includes subscriber data comprising various items of information about each member of the subscriber group and that member's dependents, if any, that are enrolled or maintained in the healthcare benefits plan. While the specific subscriber data included in a census varies among providers, all provider censuses include primary information for each member including a first and a last name, a date of birth, a social security or healthcare I.D. number, and a home address.

At step 20, subscriber data of subscribers in a subscriber group is collected or received. The subscriber data includes data of subscribers with a reported dependent eligibility status and data of at least one subscriber reported to have previously maintained an ineligible dependent under the healthcare benefits plan. The subscriber data may be collected by conducting an amnesty audit or a document audit for some or all of the subscribers in the subscriber group, or by other suitable means. In an amnesty audit, subscribers are notified about the healthcare benefits plan's eligibility rules and given a list of their enrolled dependents. The subscribers are then provided with the opportunity to voluntarily disenroll ineligible dependents within a limited time without sanction. Accordingly, an amnesty audit results in the identification of reported fraudulent subscribers, i.e., subscribers that are reported to have maintained an ineligible dependent under the healthcare plan. (Such subscribers are referred to herein as being “fraudulent” even though they may not have purposefully maintained an ineligible dependent under the plan. For instance, a subscriber that simply misunderstood the eligibility rules or failed to disenroll a dependent when he or she became ineligible is nevertheless referred to as a “fraudulent” subscriber.)

In a document audit, subscribers are asked to certify or provide proof of the eligibility of the claimed dependent. For example, subscribers may be asked to provide a marriage certificate, birth certificates, student registration records, court-ordered dependent coverage documentation, physician statements regarding dependent disabilities, and/or federal tax returns to support a claim of a dependent under the healthcare benefits plan. Accordingly, those subscribers that do not and/or cannot provide proof of the eligibility of their claimed dependent(s) are identified as reported fraudulent subscribers.

It will be appreciated that, in other embodiments, rather than collecting the subscriber data, the subscriber data may simply be received after collection by a third party.

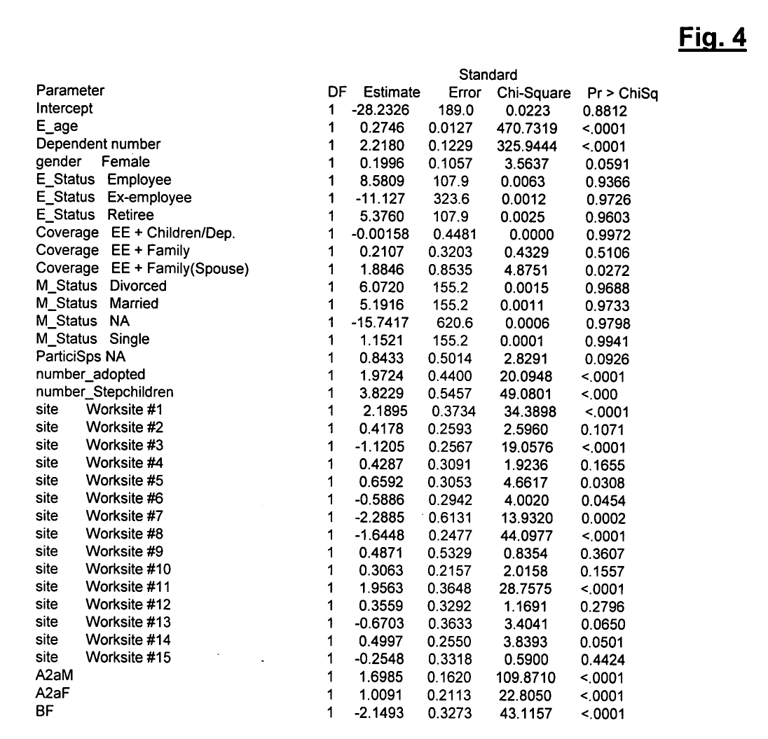

At step 22, the subscriber data, which includes data of reported fraudulent subscribers, is analyzed to develop a predictive model. The predictive model may be any suitable model as is known in the art that uses data relating to relevant factors, formulates a statistical model, and predicts the probability of an event. In accordance with the present invention, the subscriber data is analyzed to formulate a predictive, statistical, pattern-matching, heuristic, or logic-based model to predict which subscribers in the subscriber group are most likely to be maintaining coverage for an ineligible dependent. With reference to FIG. 4, an example of an output from the predictive model is shown. Because the predictive model is developed using data of reported fraudulent subscribers, the predictive model is more accurate than a model developed based on less reliable data, such as data of a random subset of subscribers or data of a predefined subset of subscribers tending to have a relatively higher proportion of fraudulent subscribers (e.g., subscribers having dependents over the age of 19 and enrolled in school full-time).

In various embodiments, the subscriber data for each subscriber that is analyzed to develop the predictive model may include but is not limited to:
Tenure in the plan—Subscriber;
Date of Hire—Employee subscribers;
Date of Birth—Subscriber;
Date of Birth—Dependent—Spouse;
Date of Birth—Dependent—Life Partner/Domestic Partner;
Date of Birth—Dependent—Child;
Last Name—Subscriber;
Last Name—Dependent—Spouse;
Last Name—Dependent—Life Partner/Domestic Partner;
Last Name—Dependent—Child;
Gender—Subscriber;
Gender—Dependent—Spouse;
Gender—Dependent—Life Partner/Domestic Partner;
Gender—Dependent—Child;
Work Location—Employee Subscriber;
SSN—Subscriber;
SSN—Dependent—Spouse;
SSN—Dependent—Life Partner/Domestic Partner;
SSN—Dependent—Child;
Job Title—Employee Subscriber;
Home Address—Subscriber;
Married—Subscriber;
Divorced—Subscriber;
Number of Dependent Children—Subscriber;
Full Time Student—Dependent—Child;
Disabled—Dependent—Child;
Health Care Claims—Dependent—Spouse; and
Health Care Claims—Dependent—Child.

In one embodiment, the development of the predictive model includes testing the accuracy of the predictive model against reported audit results. In such an embodiment, the predictive model may be tested and refined until the model delivers an acceptable level of accuracy for predicting results that match the actual reported audit results.

With continuing reference to FIG. 2, at step 24, at least a portion of the subscriber data is applied to the predictive model to generate and report a score for at least one subscriber in the subscriber group, wherein the score indicates a probability that the subscriber is maintaining an ineligible dependent in the healthcare benefits plan. In one embodiment, the score is expressed as a percentage that indicates a probability that the subscriber is fraudulent. In another embodiment, the score is expressed as a number within a range, e.g., 1-100, wherein a score of 100 indicates the highest probability that the subscriber is fraudulent. In further embodiments, the score is expressed as a color, a flag, a light, or any suitable indicating means that communicates whether the subscriber is likely to be fraudulent.

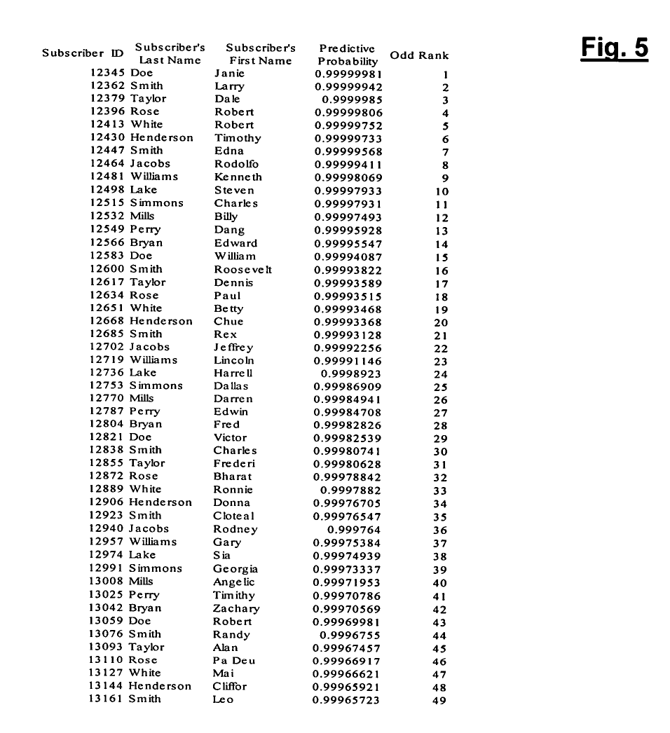

At step 26, a report of the results of applying the predictive model is created which may be customized for the user in various formats. For instance, with reference to FIG. 5, a report may be generated that lists for the healthcare plan administrator a score expressed as a probability of eligibility fraud for each subscriber in the subscriber group and that sorts the subscribers based on such a probability. Further, reports may be generated for use to show eligibility fraud trends for each benefits plan. The identification of trends may assist plan administrators in preventing continued eligibility abuse through modification of plan communications, enrollment procedures and/or audit procedures.

With continuing reference to FIG. 2, at step 28, a decision classifier is used to designate those subscribers for which the eligibility of their claimed dependent(s) should be verified, such as by a document audit, because the score indicates that such subscribers are significantly likely to be maintaining an ineligible dependent. The decision classifier is defined or elected by the user, such as an administrator of the healthcare benefits plan. The decision classifier may be a percentage of subscribers having the highest probability for fraud (e.g., the 5% of subscribers indicated as most likely to be maintaining an ineligible dependent), a number of subscribers having the highest probability for fraud (e.g., the 500 subscribers indicated as most likely to be maintaining an ineligible dependent), a score threshold (e.g., all subscribers with a greater than 85% probability of maintaining an ineligible dependent or all subscribers having a score greater than 85), a combination of these and/or other factors, or any other suitable basis for highlighting those subscribers for which further action should be taken.

At step 30, using the score and the decision classifier, the user may elect to perform one or more additional audits, such as an amnesty audit, a document audit, or both, on all or a subset of the subscribers in the subscriber group to determine whether they are in fact maintaining an ineligible dependent. Confirming information received from the audit(s), which confirms whether the subscriber(s) is maintaining an ineligible dependent, may then be used to update the predictive model back at step 24. Reviewing and using the confirming information regarding valid and invalid predictions provides a valuable opportunity for model based and neural network based learning processes. Each successive iteration of steps 24, 26, 28, and 30 can refine the predictive model and improve prediction power.

Incorporating the results of the additional audit(s) into the data used to develop the predictive model thereby provides a continuous learning process. The primary benefit of this optional continuous learning process is the development of a predictive model that is uniquely honed to perform eligibility fraud and abuse detection for a given healthcare plan's specific subscriber group. Subsequent document audits on the subscriber group can be performed immediately after the initial document audit, or at intervals (e.g, random, quarterly, annually) as part of a long-term dependent eligibility fraud detection and prevention plan.

In accordance with the described embodiment, the present invention provides the advantage of not being biased, as it assigns a score for each subscriber based on findings within the same subscriber group. The present invention thereby delivers a measurable improvement over conventional methods that either contemplate performing a document audit on all subscribers with dependents, on random subscribers with dependents, or on certain classes of subscribers with dependents such as subscribers with dependents who are (1) handicapped/disabled or (2) over 19 and full-time students.

Subscriber groups that would benefit from the described embodiment include but are not limited to:
Employer Sponsored Healthcare Plans;
Union Sponsored Healthcare Plans;
Association Sponsored Healthcare Plans;
Government Sponsored Healthcare Plans (Federal, State, Local); and
Healthcare Plans offered to the public through retail channels.

B. Separate Subscriber Groups—Using a Base Case.

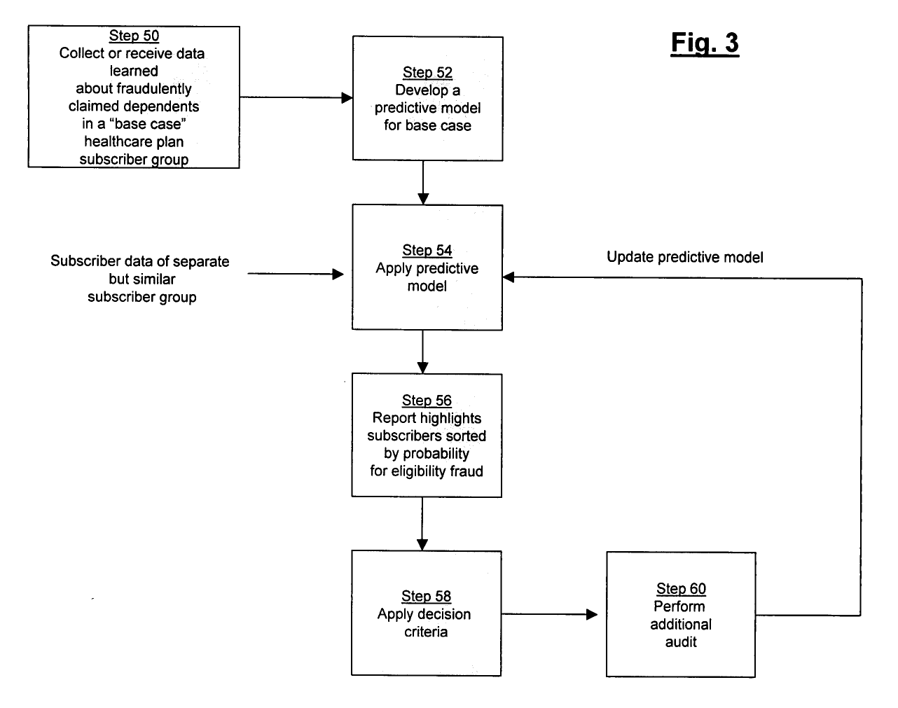

With reference to FIG. 3, a method is shown for reducing fraud in a healthcare benefits plan using the system 10 in another embodiment of the present invention wherein a predictive model developed using subscriber data of subscribers in a base case subscriber group, which includes data of reported fraudulent subscribers, is used to identify subscribers in a separate, preferably similar, subscriber group that are likely to be maintaining an ineligible dependent under a healthcare benefits plan. By way of example and without limitation, the base case subscriber group and the similar subscriber group may be similar with respect to:
Industry—e.g., Education, Textile, Banking, Retail, Healthcare, Manufacturing;
Geographic Region—e.g., Regional—Southwest, State—Wisconsin, SMSA—Chicago;
Member Status—e.g., Active Employee Subscriber Groups, Retired Employee Subscriber Groups, COBRA Groups (subscribers who have elected to maintain continued coverage in a group health plan after leaving employment);
Benefits Plan Type—e.g., all subscribers who elected the PPO, HMO, or CDHP plan; and
Benefits Plan Offeror—e.g., healthcare Plans offered to the public through retail channels such as Kaiser Permanente, Humana, BlueCross Blue Shield, Anthem, or United Healthcare.

At step 50, subscriber data of subscribers in a base case subscriber group is collected or received. The subscriber data includes data of subscribers with a reported dependent eligibility status and data of at least one subscriber reported to have previously maintained an ineligible dependent under the healthcare benefits plan. The subscriber data may be collected by conducting an amnesty audit or a document audit for some or all of the subscribers in the subscriber group, or by other suitable means. Accordingly, the collection of the subscriber data results in the identification of reported fraudulent subscribers, i.e., subscribers that are reported to have maintained an ineligible dependent under the healthcare plan. (As previously noted, such subscribers are referred to herein as being “fraudulent” even though they may not have purposefully maintained an ineligible dependent under the plan.)

It will be appreciated that, in other embodiments, rather than collecting the subscriber data, the subscriber data may simply be received after collection by a third party.

At step 52, the subscriber data, which includes data of reported fraudulent subscribers, is analyzed to develop a predictive model. As previously noted, the predictive model may be any suitable model as is known in the art that uses data relating to relevant factors, formulates a statistical model, and predicts the probability of an event. In accordance with the present invention, the subscriber data is analyzed to formulate a predictive, statistical, pattern-matching, heuristic, or logic-based model to predict which subscribers in the base case subscriber group are most likely to be maintaining coverage for an ineligible dependent. Because the predictive model is developed using data of reported fraudulent subscribers, the predictive model is more accurate than a model developed based on less reliable or unverified data, such as data of a random subset of subscribers or data of a subset of subscribers tending to have a relatively higher proportion of fraudulent subscribers.

In various embodiments, in addition to the subscriber data for each subscriber listed above, the subscriber data that is analyzed to develop the predictive model for the base case subscriber group may also include, but is not limited to:
Plan Size (number of total subscribers);
Plan's Dependent Metrics (Ratio of Dependents covered to Subscribers);
Eligibility Definition Sets (number of variations within plan, narrow definition set, wide definition set);
Plan's current documentation protocol for subscribers enrolling dependents;
Plan's utilization of online enrollment of dependents;
Plan's requirement of annual proof of full-time student enrollment for dependents who are of the age where full-time student enrollment is required; and
Plan's recent subscriber growth rate.

In one embodiment, the development of the predictive model includes testing the accuracy of the predictive model against reported audit results. In such an embodiment, the predictive model may be tested and refined until the model delivers an acceptable level of accuracy for predicting results that match the actual reported audit results.

At step 54, subscriber data of subscribers in a separate, preferably similar, subscriber group is applied to the predictive model to generate and report a score for at least one subscriber in the separate subscriber group, wherein the score indicates a probability that the subscriber is maintaining an ineligible dependent in the healthcare benefits plan. As previously noted, the score may be expressed by any suitable indicating means that communicates whether the subscriber is likely to be fraudulent.

At step 56, a report of the results of applying the predictive model is created which may be customized for the user in various formats.

At step 58, a decision classifier is used to designate those subscribers in the separate subscriber group for which the eligibility of their claimed dependent(s) should be verified, such as by a document audit, because the score indicates that such subscribers are significantly likely to be maintaining an ineligible dependent. As previously described, the decision classifier is defined or elected by the user, such as an administrator of the healthcare benefits plan, and may comprise any other suitable basis for highlighting those subscribers for which further action should be taken.

At step 60, using the score and the decision classifier, the user may elect to perform one or more additional audits, such as an amnesty audit, a document audit, or both, on all or a subset of the subscribers in the separate subscriber group to determine whether they are in fact maintaining an ineligible dependent. Confirming information received from the audit(s), which confirms whether the subscriber(s) is maintaining an ineligible dependent, may then be used to update the predictive model back at step 54, thereby providing a continuous learning process. Each successive iteration of steps 54, 56, 58, and 60 can refine the predictive model and improve prediction power. Improvements in the predictive model may be applied for the sole use of the separate subscriber group, incorporated into the base case, or both.

In accordance with the described embodiment, after developing the predictive model using the data of the base case subscriber group, subscriber data of numerous additional subscriber groups may be applied to the same predictive model at step 54. Thus, the present invention provides the advantage of not requiring a predictive model to be developed for each subscriber group, as it assigns a score for each subscriber based on findings within a separate, but preferably similar, subscriber group. The present invention thereby provides a measurable improvement over conventional methods that either contemplate performing a document audit on all subscribers with dependents, on random subscribers with dependents, or on certain classes of subscribers with dependents such as subscribers with dependents who are (1) handicapped/disabled or (2) over 19 and full-time students.

III. Difference in Data Characteristics.

Further, the present invention may be used to reduce fraud in a healthcare benefits plan based on data that is incomplete. For example, in cases where the subscriber data is collected using an amnesty audit, the reported results, i.e., the voluntary disenrollment of a dependent, may not be verified as being the result of actual fraud. In other words, although subscriber data from an amnesty audit identifies subscribers that self-identified ineligible dependents, such data does not indicate whether the ineligible dependent was being maintained as a result of subscriber fraud, or due to non-fraud reasons including oversight or confusion on the part of the subscriber. As such, the present invention uses subscriber data consisting of the following cases:
1. Subscribers who confirm eligibility for eligible dependents;
2. Subscribers who confirm eligibility for ineligible dependents and continue to commit fraud;
3. Subscribers who self identify ineligible dependents due to fraud; and
4. Subscribers who self identify ineligible dependents due to non-fraud reasons.

By contrast, typical data used in conventional fraud detection systems consists of the following cases:
(a) Non-Fraud cases classified as cases with no fraud;
(b) Fraud cases classified as cases with no reported fraud; and
(c) Fraud cases classified as fraud as reported by an auditor who confirmed the fraud.

Although Case (a) matches Case (1) above, and Case (b) matches Case (2), above, Case (c) data provides correct, known information that may not be available for a healthcare benefits plan.

Accordingly, in one embodiment of developing the predictive model, the procedure initially assumes that all subscriber data is correct. Then, procedures such as logistics regression are used with multiple attributes that are provided in the employee profiles and/or derived from domain knowledge based on profile data. Model selection procedures including stepwise regression are used to identify important explanatory variables. Then, as previously described, the prediction of this regression gives the initial estimate of a score for each subscriber.

Because the original subscriber data could have contained incorrect information, the procedure includes creation of a weighting function using the scores for updating the predictive model. For example, if the score for a given subscriber is very low and the subscriber self-identifies himself as covering ineligible dependents, the weight assigned will be relatively low and the modeling procedure will exclude the case in further modeling. Alternatively, if the score is very high, but the subscriber self-identifies himself as covering only eligible dependents, then the assigned weight will be relatively high. Importantly, the modeling procedure will involve changing the case to an ineligible case, i.e., self-correct the data. Through the use of modified weights and self-corrected data, the modeling procedure provides a weighted logistics regression that yields predictive scores.

The modeling procedure includes several iterations of the process listed above. Convergence of selected model variables and estimated model coefficients are monitored during successive iterations. The modeling procedure is terminated when a given threshold of changes in convergence monitoring parameters occurs.

It will be appreciated that instead of using the logistics regression to model data and select model terms, other modeling techniques may be applied including, but not limited to, artificial neural networks and Bayesian belief networks. The choice of the weighting function ranges from mathematical constructs, empirical models or neural networks.

IV. Case Studies.

A. Case Study 1.

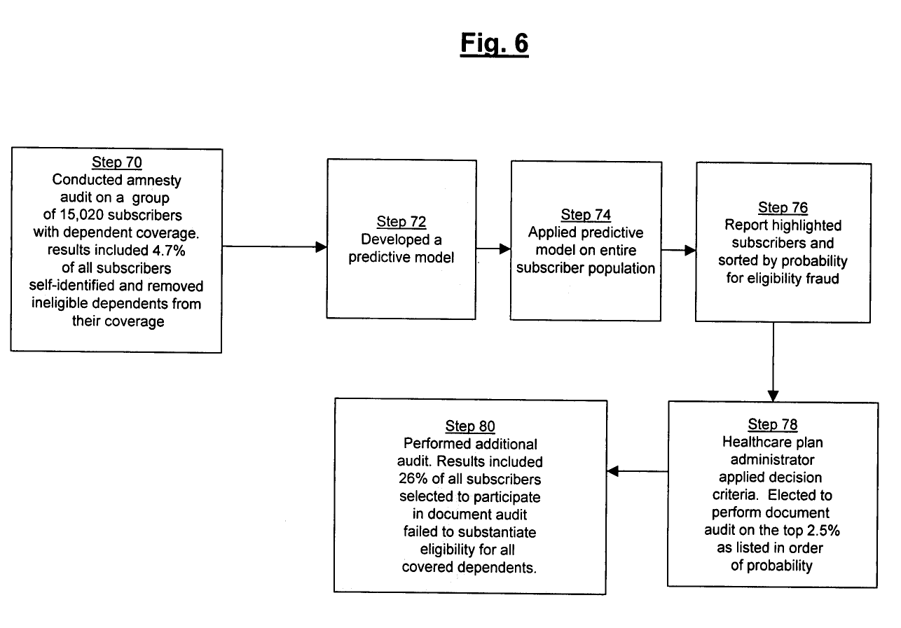

With reference to FIG. 6, a case study was performed to test the effectiveness of the present invention for reducing dependent eligibility fraud in a healthcare benefits plan. At step 70 of this study an amnesty audit was conducted for a subscriber group consisting of 15,020 subscribers having dependent coverage. As a result of the amnesty audit, 4.7% of all subscribers self-identified themselves as maintaining an ineligible dependent and voluntarily removed their ineligible dependents from coverage under the plan. At step 72 of this study, a predictive model was developed using the subscriber data collected from the amnesty audit, which included data of subscribers reported to have maintained an ineligible dependent.

At step 74 of this study, subscriber data of all subscribers was applied to the predictive model and a score was generated for each subscriber, wherein the score indicated a probability that the subscriber was maintaining an ineligible dependent under the plan. At step 76 of this study, a report was generated which highlighted those subscribers having a significant probability of maintaining an ineligible dependent and which sorted the subscribers by the probability that each was maintaining an ineligible dependent.

At step 78 of this study, the healthcare plan administrator used decision criteria to determine which subscribers should be investigated to determine whether they in fact were maintaining an ineligible dependent. The administrator elected to perform a document audit on the top 2.5% of subscribers as listed in order of probability of maintaining an ineligible dependent. At step 80 of this study, document audits were performed on the top 2.5% of subscribers. As a result, 26% of all subscribers selected to participate in a document audit failed to substantiate eligibility for all covered dependents and those dependents were disenrolled from the plan.

The results of this study indicate that the present invention is significantly more accurate than a random document audit and thereby reduces the administrative cost and negative impacts associated with conventional approaches to combating dependent eligibility fraud.

B. Case Study 2.

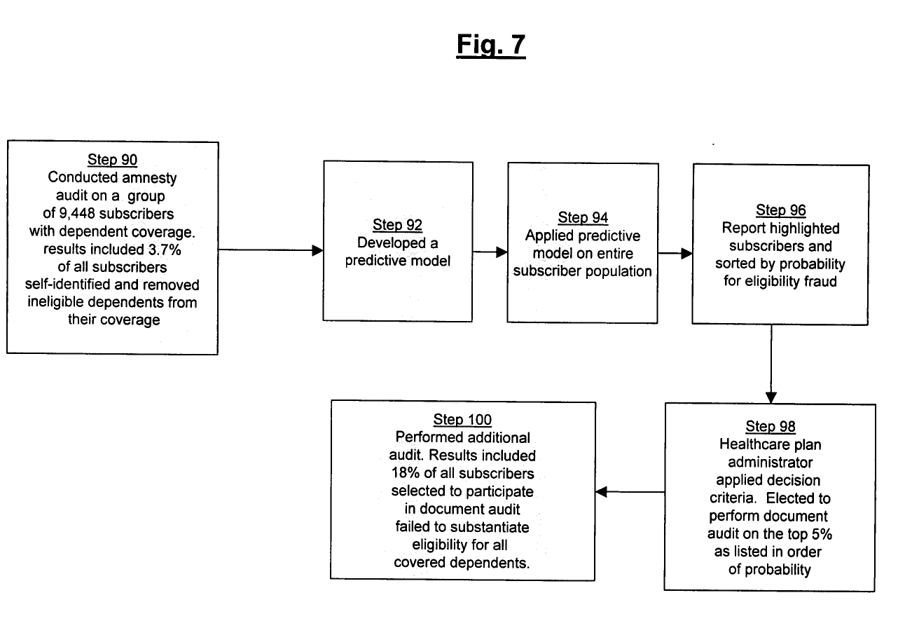

With reference to FIG. 7, a second case study was performed to further test the effectiveness of the present invention for reducing dependent eligibility fraud in a healthcare benefits plan. At step 90 of this study an amnesty audit was conducted for a subscriber group consisting of 9,448 subscribers having dependent coverage. As a result of the amnesty audit, 3.7% of all subscribers self-identified themselves as maintaining an ineligible dependent and voluntarily removed their ineligible dependents from coverage under the plan. At step 92 of this study, a predictive model was developed using the subscriber data collected from the amnesty audit, which included data of subscribers reported to have maintained an ineligible dependent.

At step 94 of this study, subscriber data of all subscribers was applied to the predictive model and a score was generated for each subscriber, wherein the score indicated a probability that the subscriber was maintaining an ineligible dependent under the plan. At step 96 of this study, a report was generated which highlighted those subscribers having a significant probability of maintaining an ineligible dependent and which sorted the subscribers by the probability that each was maintaining an ineligible dependent.

At step 98 of this study, the healthcare plan administrator used decision criteria to determine which subscribers should be investigated to determine whether they in fact were maintaining an ineligible dependent. The administrator elected to perform a document audit on the top 5% of subscribers as listed in order of probability of maintaining an ineligible dependent. At step 100 of this study, document audits were performed on the top 5% of subscribers. As a result, 18% of all subscribers selected to participate in a document audit failed to substantiate eligibility for all covered dependents and those dependents were disenrolled from the plan.

The results of this second study further indicate that the present invention is significantly more accurate than a random document audit and thereby reduces the administrative cost and negative impacts associated with conventional approaches to combating dependent eligibility fraud.

V. Additional Contemplated Uses for the Present Invention.

It will be appreciated that for any of the embodiments described herein, the healthcare benefits plan subscriber group may be segmented prior to performing an audit or an analysis based on factors including but not limited to annual enrollment trends, ease of securing data, healthcare plan priorities and healthcare claim activity.

Moreover, although the present invention has been described with respect to reducing dependent eligibility fraud and abuse, there are numerous additional applications. For example, a growing number of employers who sponsor healthcare plans are incorporating a “defensive coordination of benefits” plan provision or a “spousal surcharge” plan provision. A healthcare plan featuring a defensive coordination of benefits provision does not permit the spouse of a subscriber, who has access to group coverage through the spouse's employer, to participate as a dependent in the subscriber's plan for primary coverage. Similarly, a healthcare plan with a spousal surcharge plan provision assesses a surcharge (such as $100 per month) for a subscriber's dependent spouse who has access to group coverage through the spouse's employer, but elects to participate as a dependent in the subscriber's plan. These and other plan provisions represent innovative responses of healthcare plan administrators to combat the growing costs associated with providing healthcare plans to subscriber groups.

In this regard, it will be appreciated that the present invention could likewise be utilized to indicate subscribers having a probability of being fraudulent with respect to defensive coordination of benefits plan provisions, spousal surcharge plan provisions, or any other benefits plan eligibility provisions. As additional plan provisions are implemented in the future, in response to continued increases in the costs associated with delivering healthcare plans to subscriber groups, the present invention may be utilized as a valuable tool to detect, highlight and allow healthcare plan administrators to eliminate various acts of fraud.

While this invention has been described with reference to the described embodiments thereof, it is to be understood that variations and modifications can be affected within the spirit and scope of the invention as described herein and as described in the appended claims.

We claim:

1. A method for reducing fraud in a benefits plan comprising the steps of:
a. receiving subscriber data of at least one subscriber in a subscriber group;
b. applying the subscriber data to a predictive model, wherein the predictive model was developed using data of at least one reported fraudulent subscriber; and
c. using the predictive model to generate a score for at least one subscriber in the subscriber group, wherein the score indicates a probability that the subscriber is fraudulent.

2. The method of claim 1, wherein the at least one reported fraudulent subscriber is a member of the subscriber group.

3. The method of claim 2, wherein the at least one reported fraudulent subscriber is a member of a base case subscriber group and wherein the subscriber group and the base case subscriber group are similar with respect to industry, geographic region, member status, benefits plan type, or benefits plan offeror.

4. The method of claim 1, further comprising the steps of:
a. receiving the data of the at least one reported fraudulent subscriber; and
b. developing the predictive model using the data of the at least one reported fraudulent subscriber.

5. The method of claim 1, further comprising the steps of:
a. collecting the data of the at least one reported fraudulent subscriber; and
b. developing the predictive model using the data of the at least one reported fraudulent subscriber.

6. The method of claim 5, wherein the step of collecting the data of the at least one reported fraudulent subscriber comprises:
a. conducting an amnesty audit; and
b. identifying the at least one reported fraudulent subscriber.

7. The method of claim 5, wherein the step of collecting the data of the at least one reported fraudulent subscriber comprises:
a. conducting a document audit; and
b. identifying the at least one reported fraudulent subscriber.

8. The method of claim 1, further comprising the steps of:
a. receiving confirming information, wherein the confirming information confirms whether the subscriber is fraudulent; and
b. updating the predictive model based on the confirming information.

9. The method of claim 1, further comprising the steps of:
a. comparing the score to a threshold; and
b. if the score exceeds the threshold, determining whether the subscriber is fraudulent.

10. The method of claim 9, further comprising the step of updating the predictive model based on the determination of whether the subscriber is fraudulent.

11. The method of claim 9, wherein the step of determining whether the subscriber is fraudulent comprises conducting a document audit.

12. A method for reducing fraud in a healthcare benefits plan comprising the steps of:
a. receiving subscriber data of at least one subscriber of the healthcare benefits plan;
b. applying the subscriber data to a predictive model, wherein the predictive model was developed using data of at least one subscriber reported to have maintained an ineligible dependent under a benefits plan; and
c. using the predictive model to generate a score for at least one subscriber of the healthcare benefits plan, wherein the score indicates a probability that the subscriber is maintaining an ineligible dependent under the healthcare benefits plan.

13. The method of claim 12, wherein the benefits plan is the healthcare benefits plan.

14. The method of claim 12, wherein the benefits plan and the healthcare benefits plan are similar with respect to industry, geographic region, member status, benefits plan type, or benefits plan offeror.

15. The method of claim 12, further comprising the steps of:
a. receiving the data of the at least one subscriber reported to have maintained an ineligible dependent under the benefits plan; and
b. developing the predictive model using the data of at least one subscriber reported to have maintained an ineligible dependent under the benefits plan.

16. The method of claim 12, further comprising the steps of:
a. collecting the data of the at least one subscriber reported to have maintained an ineligible dependent under the benefits plan; and
b. developing the predictive model using the data of at least one subscriber reported to have maintained an ineligible dependent under the benefits plan.

17. The method of claim 16, wherein the step of collecting the data of at least one subscriber reported to have maintained an ineligible dependent under the benefits plan comprises conducting an amnesty audit or a document audit.

18. The method of claim 12, further comprising the steps of:
a. receiving confirming information, wherein the confirming information confirms whether the subscriber is maintaining an ineligible dependent under the healthcare benefits plan; and
b. updating the predictive model based on the confirming information.

19. The method of claim 12, further comprising the steps of:
a. comparing the score to a threshold; and
b. if the score exceeds the threshold, determining whether the subscriber is maintaining an ineligible dependent under the healthcare benefits plan.

20. The method of claim 19, further comprising the step of updating the predictive model based on the determination of whether the subscriber is maintaining an ineligible dependent under the healthcare benefits plan.

21. The method of claim 19, wherein the step of determining whether the subscriber is maintaining an ineligible dependent under the healthcare benefits plan comprises conducting a document audit.

22. A system for reducing fraud in a benefits plan comprising:
a. a predictive engine configured to apply subscriber data to a predictive model, wherein the predictive model is configured using data of at least one reported fraudulent subscriber; and
b. a reporting component configured to use an output of the predictive model to report a score for at least one subscriber, wherein the score indicates a probability that the subscriber is fraudulent.

23. The system of claim 22, further comprising an analysis engine configured to develop the predictive model using the data of the at least one reported fraudulent subscriber.

24. The system of claim 22, wherein the at least one reported fraudulent subscriber maintained an ineligible dependent under a healthcare benefits plan and wherein the score indicates a probability that the subscriber is maintaining an ineligible dependent under the benefits plan.
